(19) United States
(12) Patent Application Publication
(10) Pub. No.: US 2025/0353963 A1
(43) Pub. Date: Nov. 20, 2025

(54) PROCESS FOR PREPARING HYDROSILOXANES

(71) Applicant: Evonik Operations GmbH, Essen (DE)

(72) Inventors: Wilfried Knott, Essen (DE); Michael Ferenz, Essen (DE); Horst Dudzik, Essen (DE); Anja Brösgen, Muelheim an der Ruhr (DE)

(73) Assignee: Evonik Operations GmbH, Essen (DE)

(21) Appl. No.: 19/207,476

(22) Filed: May 14, 2025

(30) Foreign Application Priority Data
May 17, 2024 (EP) 24176575.9

(51) Int. Cl. C08G 77/10

(52) U.S. Cl. CPC C08G 77/10

(57) ABSTRACT

A process prepares unbranched hydrosiloxanes bearing dimethylhydrosiloxy groups by providing of a siloxane mixture having at least two different siloxanes and allowing the siloxane mixture to react in the presence of a sulfonic acid ion exchange resin in an equilibration reaction to form a reaction mixture, wherein the siloxanes used collectively have dimethylhydrosiloxy groups, methylhydrosiloxy groups, dimethylsiloxy groups and preferably trimethylsiloxy groups, and wherein the reaction mixture is monitored by ultrasound measurement in order to ascertain the suitable juncture for ending of the equilibration reaction, and the equilibration reaction is ended once the juncture ascertained has been reached.

### CROSS-REFERENCE TO RELATED APPLICATIONS

This application is a new U.S. Patent Application which claims priority to European Patent Application No. 24176575.9, filed on May 17, 2024, the content of which is hereby incorporated by reference in its entirety.

### BACKGROUND OF THE INVENTION

### Field of the Invention

The invention is in the field of silicone chemistry and relates in particular to a process for preparing hydrosiloxanes using ultrasound measurement.

Hydrosiloxanes, i.e. siloxanes having SiH groups, being equilibrates, play an important role as precursors, for example for further processing thereof to give polyethersiloxanes, silicone acrylates, silicone quats, silicone waxes and numerous other derivatives.

Aside from the oldest equilibration methods conducted by homogeneous catalysis, heterogeneously catalysed processes have in recent years increasingly become involved in industrial silicone production that makes use of solid-phase catalysts.

One example of a significant advantage of the acidic solid-phase catalyst in the production of hydrosiloxanes is that the liquid siloxane phase can be separated from the acidic solid-phase catalyst without complex aftertreatment, in particular without neutralization of a homogeneous acid that is otherwise typically used with subsequent removal by filtration of the salt formed.

Among the solid-phase catalysts used for equilibration of hydrosiloxanes, major significance attaches here to the macroporous sulfonic acid polystyrene resins. These are found to be particularly suitable for equilibration of siloxane systems having siloxane components that bear methylhydrosiloxy groups.

### Description of Related Art

Following this objective, the teaching of WO 2010/031654 A1 is guided in particular to the equilibration of poly(methylhydro)polydimethylsiloxane copolymers over a sulfonic acid cation exchange resin, wherein an organosiloxane used as starting material or an organosiloxane mixture at a temperature of 10° C. to 120° C. is contacted with a macrocrosslinked cation exchange resin containing sulfonic acid groups, and the resultant equilibrated organosiloxanes are isolated. The cation exchange resin used according to the teaching of WO 2010/031654 A1 is characterized in that the product P of the specific surface area thereof and the average pore diameter P thereof is ≥2.2×10⁻³ m³/kg and the specific surface area A is ≥35 m²/g, and in that it has a water content of 8 to 25 per cent by weight, based on the mass of the cation exchanger used.

WO 2010/074831 A1 describes a process for preparing siloxanes, comprising the converting of at least two siloxanes in the presence of an ion exchange resin catalyst comprising 6% to 19% by weight of water, wherein preferably at least one of the siloxanes comprises at least one silicon-bonded hydrogen atom, and wherein preferably at least one of the siloxanes is poly(methyl)hydrosiloxane or a cyclic siloxane. In particular, this describes the reacting of at least two siloxanes over a water-containing ion exchange resin catalyst, wherein at least one siloxane comprises a silicon-bonded hydrogen atom and wherein the ion exchange resin catalyst is recovered after the reacting and a water loading of 6 to 19 per cent by weight based on the dry weight of the ion exchange resin catalyst is established by addition of water to the ion exchange resin catalyst, and then at least two siloxanes are reacted again in the presence of that ion exchange resin catalyst. Reactants chosen in the examples of WO 2010/074831 A1 are octamethylcyclotetrasiloxane and tetramethyldisiloxane, and the content—determined via gas chromatography—of octamethylcyclotetrasiloxane (D₄) in the siloxane matrix at the end of the reaction is considered to be an indicator of establishment of equilibrium. Moreover, a defined SiH content of the reaction mixture is referenced only at the start of the reaction. However, WO 2010/074831 A1 does not give any figures for the SiH content of the reaction mixture at the end of each reaction. Aside from the D₄ content determined via gas chromatography, however, the SiH content of the reaction product is of even greater importance since all the customary framework-building further reactions (for example hydrosilylation or dehydrogenative reactions) require this reference parameter to fix the respective stoichiometry.

Likewise using the example of a simple a,w-dihydropolydimethylsiloxane, DE 102014211680 A1 discloses its teaching for production of siloxanes with regeneration-free further use of the ion exchange resins, which is based on the reacting of at least two siloxanes over the sulfonic acid cation exchange resin, using at least one OH-functional siloxane. In the examples of DE 102014211680 A1, α,ω-dihydropolydimethylsiloxane and decamethylcyclopentasiloxane were used. In the context of the disclosure of DE102014211680A1, it is found that a multitude of sulfonic acid cation exchange resins are suitable for the equilibration of α,ω-dihydropolydimethylsiloxanes that proceeds with SiOSi rearrangement. However, DE102014211680A1 does not show how to obtain equilibrated, i.e. very substantially equally distributed SiH siloxanes having both chain-terminal and pendant SiH functions.

Also cited here are the following prior art documents that are concerned with the production of differently structured hydrosiloxanes over a sulfonic acid cation exchange resin: WO 2010/031654 A1, DE102005001039 A1, EP 1 439 200 A1, EP 2 628 763 A1, and published specification DE 21 52 270 A.

SiH function-conserving equilibration of siloxanes bearing both dimethylhydrosiloxy groups and methylhydrosiloxy units in the equilibration matrix has constituted an enormous challenge to date, and so superacids such as perfluoroalkanesulfonic acids, particularly trifluoromethanesulfonic acid and perfluorobutanesulfonic acid, are still the preferred homogeneous catalysts for the industrial equilibration of these particular hydrosiloxanes.

It will become increasingly difficult in the coming years to overcome this challenge, preferably relating to hydrosiloxanes of the general structure type

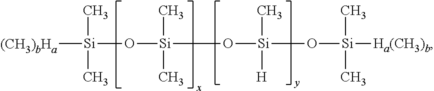

not least because there are planned measures in Europe for EU-wide restriction of per- and polyfluorinated alkyl substances (PFAS), which would also affect tried-and-tested homogeneous equilibration catalysts, for example trifluoromethanesulfonic acid.

The particular technical challenge in the equilibration of these unbranched hydrosiloxanes that bear dimethylhydrosiloxy groups but also still have methylhydrosiloxy groups and dimethylsiloxy groups lies in achievement of a very substantially statistical uniform distribution of SiH functions along the oligomer chain, without too many of the sensitive dimethylhydrosiloxy groups being lost as a result of dehydrogenative processes.

By comparison with perfluorinated superacids, the effective acidity of sulfonic acid ion exchange resins in siloxane matrices containing SiH groups is distinctly lower, and so it is very important when using sulfonic acid ion exchange resins to find the suitable reaction parameters for the respective equilibration system.

The required acidity is specifically guided here by the equilibration task to be achieved, i.e. by the structure of the desired hydrosiloxane. The synthesis of α,ω-dihydropolydimethylsiloxanes places the lowest demands on the acidity exerted by the catalyst, i.e. its ability to provide protons. If, for example, a mixture consisting of octamethylcyclotetrasiloxane and tetramethyldisiloxane is converted under acidic catalysis to α,ω-dihydropolydimethylsiloxanes, theoretically only one proton is needed for the opening of an octamethylcyclotetrasiloxane molecule, initiated by protonation of the oxygen atom in an SiOSi bond present therein. It is likewise the case that only one proton is theoretically required for the opening of the SiOSi bond present in the tetramethyldisiloxane molecule. Adjustment of the oligomer chain distribution additionally requires comparatively low protic activity.

However, the conditions are completely different in the case of those copolymeric siloxanes which contain methylhydrosiloxy units (DH units) and dimethylsiloxy units (D units) in addition to trimethylsiloxy groups (M units) and which are prepared, for example, from poly(methylhydro)siloxane and octamethylcyclotetrasiloxane and hexamethyldisiloxane under acidic catalysis. The opening of an octamethylcyclotetrasiloxane molecule after protonation of the oxygen atom in one of the 4 SiOSi bonds present therein theoretically requires only one proton. It is likewise the case that only one proton is theoretically required for the initiation of the opening of the SiOSi bond present in the hexamethyldisiloxane molecule. The molecular breakdown of the poly(methylhydro)siloxane also theoretically requires only 1 proton each siloxanyl bond (SiOSi bond).

In order, however, to achieve a statistical distribution of the methylhydrosiloxy units along the oligomer chains of the desired poly(methylhydrosiloxane)-polydimethylsiloxane copolymer within the time window of the reaction, a far greater number of protons are needed per unit volume of reaction mixture since only virtually simultaneous breaking and reforming of multiple SiOSi bonds results in a copolymer that does not have any cumulation(s) of methylhydrosiloxy units within the siloxane oligomer chains. This purely statistical-theoretical consideration of the acidity required for the equilibration of such siloxane copolymers is experimentally supported by the publication by G. Sauvet, M. Moreau, G. Helary, E. Daudet, P. Cancouet, “Functional polysiloxanes. I. Microstructure of poly(hydrogenmethylsiloxane-co-dimethylsiloxane)s obtained by cationic copolymerization” in J. Polymer Science, Part A: Polymer Chemistry Vol. 38, 826-36 (2000), in which the authors (on page 833, ibid.) come to the clear conclusion that a siloxane bond (SiOSi) between two D^{H} units is less reactive than that between two D units, which directly influences the part-reactions, such as backbiting, crosslinking and acidolysis, that are involved in acidic equilibration.

Cumulation in the sense of juxtaposition of methylhydrosiloxy groups should preferably be avoided as far as possible, since the subsequent usefulness of the hydrosiloxane equilibrates in hydrosilylation reactions, particularly in those in which, for example, polyether mixtures are used to obtain polyethersiloxanes for demanding surfactant applications, for example as stabilizer in polyurethane foams, is linked directly to the structural feature of copolymers that has polyether-bearing Si atoms distributed over the oligomer chains as randomly as possible, i.e. isolated from one another as far as possible, because they are separated from one another by D units.

Sauvet et al. (page 835, right-hand column, ibid.) conclude that knowledge of the distribution of D and D^{H} units in the chain is the key to understanding the properties of the (SiH) copolymers per se and many of the other properties of the functionalized derivatives derived therefrom, and refer to the direct influence of the distribution of D and DH units in the chain on the reaction rate in hydrosilylation reactions.

In this context, P. Cancouet, S. Pernin, G. Helary and G. Sauvet, in their article “Functional polysiloxanes. II. Neighboring effect in the hydrosilylation of poly(hydrogenmethylsiloxane-co-dimethylsiloxane)s by allylglycidylether” in J. Polymer Science, Part A: Polymer Chemistry, Vol. 38, 837-45 (2000), investigated the neighbouring group effect in the hydrosilylating addition of allyl glycidyl ether onto poly(methylhydrosiloxane)-polydimethylsiloxane copolymers and demonstrated that the presence of methylhydrosiloxy diads (D^{H}D^{H}) leads to accelerated hydrosilylation, while isolated D^{H} units surrounded by D units (DD^{H}D) exhibit slower reaction kinetics. Against the background of this finding, it will be apparent to those skilled in the art that the microstructure of the hydrosiloxanes, particularly in the case of the addition of polyether mixtures with their range of individual reactivities, has a crucial influence on the later target structure of the polyethersiloxane copolymer.

Methods of determining molecular fine structure in hydrosiloxanes are known. For instance, G. Sauvet et al. in J. Polymer Science, Part A: Polymer Chemistry Vol. 38, 826-36 (2000) use high-resolution ²⁹Si NMR spectroscopy in particular to detect diads, triads, pentads, etc., i.e. cumulations in the sense of direct juxtapositions of methylhydrosiloxy groups, in a poly(methylhydrosiloxane)-polydimethylsiloxane copolymer.

To date, however, NMR technology as an in-process analysis method, specifically as a real-time method, has not found a place in the industrial production of polyorganohydrosiloxanes, this being due to factors including the costs of the equipment to be installed but in particular also the fundamental problem of accommodating sources of extremely strong electromagnetic radiation, such as NMR magnets and measurement heads, in an operationally safe manner in explosion-protected production plants.

The teaching of WO2022/132446 A1 seeks to address the question of an in-process analysis by using, specifically supported therein by examples of poly(methylhydro)polydimethylsiloxane copolymers, vibrational spectroscopy methods such as infrared spectroscopy and Raman spectroscopy in order to ascertain directly mutually linked methylhydrosiloxy units (D^{H}D^{H}) and methylhydrosiloxy units isolated by dimethylsiloxy units (DD^{H}D) in the acid-catalysed equilibration of siloxanes acting as D source and siloxanes acting as D^{H} source, in order to assess the degree of distribution achieved. Focussing on the curing rate in siloxane elastomers, a direct relationship is seen between the concentration of isolated, i.e. statistically distributed, methylhydrosiloxy units, ascertained by vibrational spectroscopy, and the curing kinetics when using the respective SiH copolymer. For example (ibid. page 18, Table 3), an SiH copolymer from Batch 1, after an equilibration time of 3 hours and with a decoupled SiH IR intensity of 2.08, when introduced into an elastomer system, takes 144.3 seconds for through-curing, whereas an SiH copolymer originating from Batch 7, after an equilibration time of 16 hours and with a decoupled SiH IR intensity of 3.32, already leads to curing of the elastomer system after only 61.4 seconds.

Addressing in particular a wide variety of different curing systems (condensation- and/or hydrosilylation-curable products) as target products, the method presented in WO2022/132446 A1 is intended to help to minimize batch times and simultaneously to achieve higher statistical uniformity of the equilibrated SiH copolymer. However, WO2022/132446 A1 does not teach which route should be taken in order to achieve very substantially statistically uniform hydrosiloxane equilibrates that especially also contain dimethylhydrosiloxy groups.

It is known that the propagation of ultrasound in liquid media can be used for determination of concentration and density inter alia. For example, A. Zips in his article “Prozesskontrolle mittels Ultraschall” [Process Control by means of Ultrasound] in Technisches Messen 67 (2000), 201-207, and B. Henning in his article “Die akustische Impedanz als Messgröβe zur Charakterisierung flüssiger Stoffsysteme” [Acoustic Impedance as Measurement Parameter for Characterization of Liquid Systems of Matter] in Technisches Messen 71 (2004), 492-500, concentrate on theory and basic applications of ultrasound for measurement of concentration in liquids.

Preferably with regard to silicone polyether copolymers that are used in very sensitive applications, for example in the case of rigid polyurethane foam stabilizers, the present invention is concerned with means of achieving a very substantially statistical uniform distribution of SiH functionality in hydrosiloxanes that have both pendant SiH in the form of methylhydrosiloxy groups and dimethylhydrosiloxy groups and dimethylsiloxy groups, and preferably also proportions of trimethylsiloxy groups.

### SUMMARY OF THE INVENTION

It was an object of the present invention to provide an equilibration process for hydrosiloxanes that preferably permits assessment of the equilibrate quality at the site of production. This equilibration process is to be suitable in particular for those hydrosiloxanes that have both pendant SiH in the form of methylhydrosiloxy groups and dimethylhydrosiloxy groups and dimethylsiloxy groups, and preferably also proportions of trimethylsiloxy groups.

### BRIEF DESCRIPTION OF THE DRAWINGS

FIG. 1 shows an illustrative shift region of the triad signals containing methylhydrosiloxy groups with accompanying integrals/taken from the ²⁹Si NMR spectrum in the context of Example 1.

FIG. 2 shows an illustrative evolution of the percentage of isolated methylhydrosiloxy groups (=DD^{H}D) in the hydrosiloxane equilibrate based on the sum total of all methylhydrosiloxy groups/(DD^{H}D)// (D^{H} tot.) as a function of equilibration time t in the context of Example 1, where the percentage of isolated methylhydrosiloxy groups was calculated by dividing the integral of the signal that can be assigned to the DD^{H}D groups in the ²⁹Si NMR spectrum,/(DD^{H}D), by the sum of all integrals that can be assigned to the D^{H} groups in the ²⁹Si NMR spectrum,/(D^{H} tot.).

FIG. 3 shows an illustrative plot of the evolution of the temperature-corrected speed of sound v (corr.), determined experimentally for a hydrosiloxane at T_{reaction}=40° C., as a function of reaction time t in the context of Example 1, and an illustrative plot of the evolution of the derivative of the temperature-corrected speed of sound with respect to time as determined experimentally for a hydrosiloxane at T_{reaction}=40° C. (=intensity change represented as the difference quotient Δv(corr.)/Δt) as a function of reaction time in the context of Example 1.

FIG. 4 shows an illustrative plot of the evolution of the percentage of isolated methylhydrosiloxy groups (=DD^{H}D), ascertained by ²⁹Si NMR analysis, in the hydrosiloxane equilibrate based on the sum total of all methylhydrosiloxy groups/(DD^{H}D)//(D^{H} tot.) as a function of equilibration time tin the context of Example 1, and an illustrative plot of the temperature-corrected speeds of sound v (corr.) for the hydrosiloxane produced in Inventive Example 1 as a function of equilibration time t.

### DETAILED DESCRIPTION OF THE INVENTION

The inventors have now found that, surprisingly, the production of hydrosiloxane equilibrates can be undertaken successfully using sulfonic acid ion exchange resin, wherein the reaction mixture is monitored by ultrasound measurement in order to be able to determine a suitable juncture for ending of the reaction. Ultrasound measurement preferably serves here for detection of the speed of sound in the reaction mixture.

The abovementioned object is achieved by the subject matter of the invention. The invention provides a process for preparing unbranched hydrosiloxanes bearing dimethylhydrosiloxy groups, comprising: providing a siloxane mixture comprising at least two different siloxanes and allowing said siloxane mixture to react in the presence of a sulfonic acid ion exchange resin in an equilibration reaction to form a reaction mixture,
wherein the siloxanes used collectively have dimethylhydrosiloxy groups, methylhydrosiloxy groups, dimethylsiloxy groups and preferably trimethylsiloxy groups, and wherein
   (a) the reaction mixture is monitored by ultrasound measurement in order to ascertain the juncture for ending of the equilibration reaction,
   (b) the equilibration reaction is ended once the juncture ascertained in (a) has been reached.

The ultrasound measurement serves here for detection of the speed of sound in the reaction mixture.

“Ultrasound measurement” in the context of the invention means the metrological detection of the speed of sound in the reaction mixture with the aid of soundwaves within the frequency range of ultrasound.

The invention preferably enables SiH-conserving production of acid-free hydrosiloxanes having methylhydrosiloxy groups and having dimethylhydrosiloxy groups and dimethylsiloxy groups, and preferably also having proportions of trimethylsiloxy groups, and having a very substantially statistical uniform distribution of the SiH functions present therein over the oligomer chains.

Ultrasound is known per se. This means sound having frequencies in the range from 20 kHz to 1 GHz.

Instruments or measurement technology suitable for ultrasound measurement in the context of the invention are commercially available. It is possible to use, for example, LiquiSonic® devices from SensoTech GmbH (Magdeburg-Barleben, Germany) or else, for example, devices from Mat Mess-und Analysentechnik Dr. Frank Dinger/(Hofgeismar, Germany). Such devices can enable reliable detection and recording of the speed of sound and the derivative thereof with respect to time.

A preferred juncture for ending of the equilibration reaction is that juncture at which the equilibration equilibrium has been attained in chemical terms, which is preferably that juncture at which, for example, the triad distribution along the siloxane oligomer chains does not undergo any significant change, meaning that it preferably remains constant over time within the scope of the accuracy that can be visualized by the ²⁹Si NMR analysis. This desired consistency would preferably be defined by the quotient Q=/(DD^{H}D)//(D^{H} tot.). If Q changes preferably by less than 0.02/hour, the statistical uniform distribution is considered, for example, to be achieved. This is associated, for example, with the concentration of siloxane cycles (D₄+D₅+D₆) detectable by gas chromatography also preferably remaining constant.

Ultrasound measurement enables monitoring of the equilibration reaction over the entire course of the reaction and makes it possible, in a simple manner, to ascertain the preferred juncture for ending of the equilibration reaction, preferably without having to resort to the aforementioned ²⁹Si NMR analysis. But it is preferably possible to make supplementary use of the aforementioned ²⁹Si NMR analysis.

It is preferable that the ultrasound measurement detects the speed of sound in the reaction mixture and/or the derivative of the speed of sound after the time in the reaction mixture.

The speed of sound (formula v) is defined as ds/dt, i.e. as the derivative of the distance travelled by sound(s) with respect to time (t). It is reported in m/s.

The derivative of the speed of sound with respect to time is defined as dv/dt with the unit m/s².

The present invention can make it possible, for example, via consideration of the change of speed of sound in the reaction mixture or, for example, via consideration of the derivative of the speed of sound with respect to time, to infer the attainment of a preferably desired equilibration target in order thus to ascertain the suitable juncture for ending of the equilibration reaction.

It is preferable that the suitable juncture for ending of the equilibration reaction is determined via the change in speed of sound in the reaction mixture.

Preferably, the speed of sound in the reaction mixture prior to commencement of the equilibration reaction is compared with the progression of the speed of sound as the equilibration reaction progresses. This comparison enables simple monitoring of the reaction. It is preferable that the effect of the measurement temperature on the speed of sound is first ascertained in the respective medium in question, preferably in the unbranched hydrosiloxane bearing dimethylhydrosiloxy groups in question, in order to determine a correction function such that measured speeds of sound can be converted to temperature-corrected speeds of sound.

The “respective medium in question” means the starting mixture of siloxane reactants which is used for equilibration, the hydrosiloxanes that derive therefrom and have not yet been fully equilibrated, and more preferably in accordance with the invention the equilibrated, unbranched hydrosiloxane bearing dimethylhydrosiloxy groups.

“Correction function” in the context of the invention means the simple mathematical function that maps the effect of temperature on the speed of sound in the respective medium in question, preferably the respective hydrosiloxane.

“Temperature-corrected speed of sound” in the context of the invention therefore means a speed of sound that depends solely on the composition of the respective medium in question.

In order to ascertain the correction function that maps the effect of temperature on the speed of sound in the medium in question, preferably in the hydrosiloxane in question, it is preferably possible to measure the speeds of sound within a temperature range between Tₘᵢₙ and Tₘₐₓ, where the later measurement temperature should of course be within this temperature range, and the pairs of values obtained are connected to one another by a fitted straight line. Tₘᵢₙ means 20° C. and Tₘₐₓ means 50° C.

The slope of this straight line then gives the change in speed of sound per degree Celsius as the derivative for the respective reference temperature T (reference). “Reference temperature T (reference)” means the desired conversion temperature.

For the respective medium in question, preferably hydrosiloxane, it is thus possible to ascertain a numerical value for the slope of the straight line in (m/s)/° C., such that the measured speeds of sound v (measurement) can be converted to temperature-corrected speeds of sound v (corr.):

$$v ( corr . ) = v ( measurement ) - slope value ( m / s ) / °C . * ( T ( reference ) - T ( measurement ) ) .$$

A very particularly suitable juncture for ending of the equilibration reaction has preferably been attained when the change in speed of sound is less than 0.25% per 15 minutes, preferably less than 0.15% per 15 minutes.

The inventors have also found that optionally performable accompanying high-resolution ²⁹Si NMR spectroscopy can preferably make it possible to correlate the measurement data from the ultrasound measurement with the conclusions with regard to the microstructure of the resultant equilibrates that are obtainable from NMR spectroscopy, and preferably to utilize this data comparison for further ultrasound measurements in such a way that the triad distribution of methylhydrosiloxy groups in the siloxane oligomer chains can be unambiguously determined by ultrasound indices.

The term “microstructure” means the manner of distribution of the methylhydrosiloxy groups along the siloxane chain.

The term “triads” in each case means three Si units bonded via two siloxanyl bonds, for example DD^{H}D vs. DD^{H}D^{H} vs. D^{H}D^{H}D^{H} vs. MD^{H}D vs. MD_{H}D_{H} vs. M^{H}D^{H}D vs. M^{H}D^{H}D^{H}. In the context of this invention, the following triads in particular are considered: DD^{H}D vs. DD^{H}D^{H} vs. D^{H}D^{H}D^{H}.

The term “triad distribution” in the context of the invention therefore means the population of these triads DD^{H}D vs. DD^{H}D^{H} vs. D^{H}D^{H}D^{H}, determinable by ²⁹Si NMR spectroscopy.

It is preferable that samples are taken from the reaction mixture in the course of equilibration and preferably analysed with the aid of ²⁹Si NMR spectroscopy,
wherein the evaluation preferably involves consideration of all integrals of the shift range of −34.0 to −40.0 ppm that is of relevance to the methylhydrosiloxy triads and the integral of the triads that represent an isolated methylhydrosiloxy group (DD^{H}D or else MD^{H}D), which appears in the shift range from −36.8 to −38.2 ppm. In simplified terms, in the context of the teaching of the invention, reference will be made hereinafter solely to the DD^{H}D triads, although it is clear that the NMR signal of the MD^{H}D triads will also be present therein in the spectrum at a similar chemical shift.

Preferably, for each sample taken, the quotient Q can be ascertained from the integration value which is ascertained for the DD^{H}D triads, and the cumulative value of the integrals over all methylhydrosiloxy units,
in order to detect the evolution of the percentage of isolated methylhydrosiloxy groups (DD^{H}D) in the reaction mixture based on the sum total of all methylhydrosiloxy groups as a function of the equilibration time.

It is preferable here to use the integrated signal intensities of the ²⁹Si NMR spectrum in the shift range around −35 ppm for analysis of the respective triad distribution (DD^{H}D vs. DD^{H}D^{H} vs. D^{H}D^{H}D^{H}).

Under isothermal reaction conditions as achievable by the use of a reaction calorimeter, for example, it is preferably possible in a simple manner to use the evolution of the speed of sound over the reaction time to monitor the progress of the reaction.

Under conditions of practical operation, however, such idealized temperature control as in the reaction calorimeter can be achieved only with difficulty. As is well known, the speed of sound in a particular medium is also dependent on temperature. Taking account of this effect, it may therefore be particularly preferable in accordance with the invention for the non-isothermal reaction regime to ascertain a correction function that maps the dependence of the speed of sound in the respective equilibrate as a function of temperature. For the purpose of the later evaluation of measurement data, it may be preferable then to convert the recorded speed of sound to a defined reference temperature with the aid of the correction function ascertained.

Combined with the aim of recognizing the endpoint of equilibration (or ascertaining the suitable juncture for ending of the equilibration reaction), it is particularly preferable to choose the respective finished equilibrate as reference medium and to ascertain the dependence of the speed of sound on temperature therein. It is preferably possible to proceed from a linear correlation within the chosen temperature range (Tₘᵢₙ=20° C. and Tₘₐₓ=50° C.) and to derive a corresponding straight-line equation from a small number of pairs of values.

Assuming identical reaction conditions, it is thus preferably possible to ascribe an individual speed of sound and a corresponding specific triad distribution to any individual hydrosiloxane structure at any reaction time.

Once these characteristic parameters have been ascertained in this way for a specific structure type of hydrosiloxane, the method is applicable in a simple and reliable manner, for example for monitoring and assessment of any equilibration conducted under different catalysis.

In this context, it is preferably possible to make statements as to the achieved statistical uniformity of the equilibrated hydrosiloxane, or preferably also to answer the question of whether the equilibrate has already attained the desired distribution of methylhydrosiloxy groups after a particular reaction time.

If the difference in speeds of sound that has been experimentally determined for a hydrosiloxane and preferably temperature-corrected (speed of sound in the equilibrate minus speed of sound in the equilibration mixture) is normalized to 100%, it is found that the desired statistical uniformity of the SiH siloxane has already been attained when the change in speed of sound is preferably less than 0.25% per 15 minutes, preferably less than 0.15% per 15 minutes.

What is meant by statistical uniformity of the SiH siloxane is that the methylhydrosiloxy units are in very substantially statistical distribution along the siloxane chain.

The preferred correlation or preferred normalization of the speed of sound by high-resolution ²⁹Si NMR spectroscopy can preferably make it possible by the ultrasound measurement method to arrive immediately and directly at quality assessments in production (in-line) that can otherwise only be obtained via complex sampling and analysis at a site remote from the production.

The present invention can thus preferably enable not only reliable endpoint recognition in the acid-catalysed equilibration of hydrosiloxanes, which is important for the optimization of space-time yields and batch cycle times, but can preferably also enable reproducibly controlled targeting of hydrosiloxanes of particular microstructure, which is crucial for the quality of the active surfactants (polyethersiloxanes) produced therefrom.

The process according to the invention can preferably also enable countering of any decline in activity that occurs in heterogeneous catalysts, for example the sulfonic acid resins, over different production cycles.

Dedicated to the precept of quality, it is preferably possible to target a hydrosiloxane of particular microstructure. An exhausted solid-phase catalyst would become apparent in that longer reaction times are required for attainment of that equilibration target. With the aid of the process according to the invention, it is then preferably possible to correspondingly extend the reaction times. Preferred indicators for the achievement of the equilibration target and hence the formation of a preferably desired microstructure in the hydrosiloxane copolymer are the speed of sound in the equilibrate, and more preferably the derivative of the speed of sound with respect to time, i.e. the change in the speed of sound.

The process according to the invention serves for production of unbranched hydrosiloxanes bearing dimethylhydrosiloxy groups. Preferred unbranched hydrosiloxanes bearing dimethylhydrosiloxy groups are equilibrated hydrosiloxanes that satisfy the following average formula:

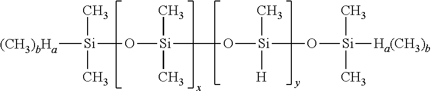

where

$$3 \leq x \leq 100 , preferably 30 \leq x \leq 80 ,$$

$$1 \leq y \leq 30 , preferably 2 \leq y \leq 10 ,$$

$$a + b = 1$$

$$0.4 \leq a \leq 1. , preferably 0.6 \leq a \leq 0.95 ,$$

$$0 \leq b \leq 0.6 , preferably 0.05 \leq b \leq 0.4 ,$$

$$more preferably x + y + 2 \geq 13 .$$

A sulfonic acid ion exchange resin is used in the process according to the invention. Such sulfonic acid ion exchange resins are known per se.

Preference is given to using a macrocrosslinked, water-containing cation exchange resin containing sulfonic acid groups, wherein the product P thereof of specific surface area and average pore diameter P is ≥2.2×10⁻³ m³/kg and the specific surface area A is ≥35 m²/g, and which has a water content of 6 to 16 per cent by weight, preferably a water content of 8 to 12 per cent by weight, based on the weight of the cation exchange resin. Such preferred cation exchange resins are likewise known per se.

The equilibration reaction according to the invention is preferably is conducted at a temperature of 20° C. to 50° C., preferably of 35° C. to 45° C., within a period preferably of 4 to 10 hours, preferably within a period of 5 to 8 hours.

The process according to the invention, especially preferably the equilibration reaction, is preferably conducted at a pressure preferably of 800 mbar to 1200 mbar, more preferably of 950 mbar to 1100 mbar.

It may be preferable to add water to the reactant system according to the invention comprising at least two different siloxanes as specified in embodiment 1 in order, for example, to counter any possible depletion of water in the sulfonic acid cation exchange resin.

This can preferably be achieved by placing the sulfonic acid cation exchange resin, for example, in a receptacle provided with suitable sieve trays and/or slotted screens, and then, for example with the aid of a conveying unit, preferably a pump, conveying the equilibration mixture over the cation exchange resin thus fixed, and connecting this arrangement consisting of receptacle and pump, for example, to a stirred reactor containing the measurement probe, such that this preferred interconnection gives rise to a reaction loop overall.

Such a local liquid-solids separation can preferably also be achieved by suspending the cation exchange resin directly in the equilibration mixture in a stirred reactor and then immersing an ultrasound measurement probe, protected by a screen construction for example, into the suspension such that, as a result of a screen mesh size adapted to the particle diameter of the cation exchange resin, only liquid volume elements are able to pass through the screen and hence pass the measurement probe.

The example which follows serves merely to further elucidate the present invention and does not constitute any restriction of the present invention whatsoever.

### EXAMPLE

In the context of the present invention, ²⁹Si NMR spectra were recorded with a measurement frequency of 79.506 MHz in a Bruker Avance Neo 400 spectrometer, equipped with a Z 179883 sample head with a gap width of 10 mm, dissolved at 22° C. in CDCl₃ and versus tetramethylsilane (TMS) as external standard [d(²⁹Si)=0.0 ppm].

### Example 1

In an RC1 reaction calorimeter (from Mettler-Toledo) equipped with a LiquiSonic® ultrasound measurement probe from SensoTech GmbH (connected to a signal transducer from LiquiSonic®Lab), a stirred initial charge of 119 g of a poly(methylhydro)siloxane (SiH value=15.60 mol/kg) together with 377 g of an α,ω-dihydropolydimethylsiloxane (SiH value =2.88 mol/kg) and 1304 g of decamethylcyclopentasiloxane was heated to 40° C. The reaction calorimeter was connected via the base outlet to the lower opening, in the form of a tube connector, of a vertical cylindrical glass double frit (porosity P1) consisting of shell and core, containing an initial charge of 108 g of a sulfonic acid cation exchange resin (Lewatit® K2621) that had been predried to a water content of 10%. The upper opening of the double frit, likewise in the form of a tube connector, was connected with the aid of a hose on the suction side to a dosage membrane pump (model: ProMinent Gamma/L), which was connected on the pressure side via a hose to a filling tube that was immersed into the reaction calorimeter.

Overall, the interconnection of the plant components described here thus constituted a closed circuit (reaction loop).

The membrane pump was adjusted to a volume flow rate of 11|per hour, and the reaction mixture was allowed to pass in circulation through the charge of cation exchange resin in the double frit with constant stirring in the reaction calorimeter and with pumped circulation for 6 hours.

With the aid of a syringe provided with a long cannula, samples of 5 ml each were taken from the reaction calorimeter through a septum cap at times t=0, t=30 minutes, t=60 minutes, t=90 minutes, t=120 minutes, t=180 minutes, t=240 minutes, t=300 minutes and t=360 minutes, and then analysed with the aid of ²⁹Si NMR spectroscopy.

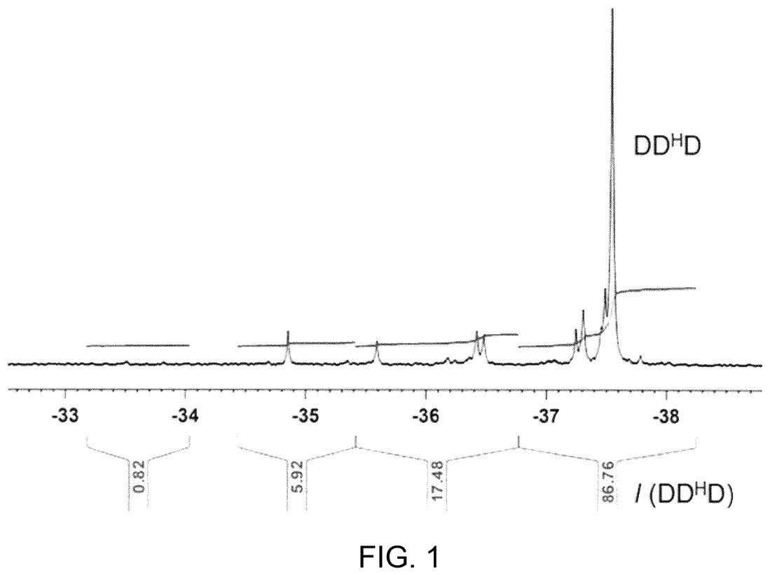

In the evaluation of the recorded ²⁹Si NMR spectra, all integrals in the shift range of −34.0 to −40.0 ppm that are of relevance for the methylhydrosiloxy triad signals, and in particular the integral of the triad signal that represents an isolated methylhydrosiloxy group (DD^{H}D), which appears in the shift range of −36.8 to −38.2 ppm, were considered (see FIG. 1).

For each live reaction sample taken, the quotient of the integration value that was ascertained for the DD^{H}D triad signal and the cumulative value of the integrals across all the signals containing methylhydrosiloxy units (=/(D^{H} tot.) was formed and normalized to 100% (see Table 1).

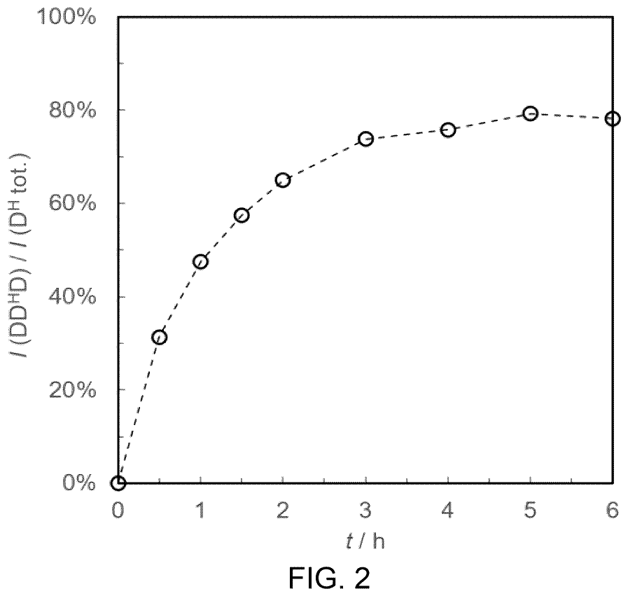

On the basis of these values thus ascertained, it was possible to show the evolution of the percentage of isolated methylhydrosiloxy groups (=DD^{H}D) in the hydrosiloxane equilibrate based on the sum total of all methylhydrosiloxy groups as a function of equilibration time (see FIG. 2).

At a reaction temperature of 40° C., both the speed of sound and the derivative of the speed of sound with respect to time were detected. The speed of sound was detected over the entire reaction time, and the change in speed of sound every minute.

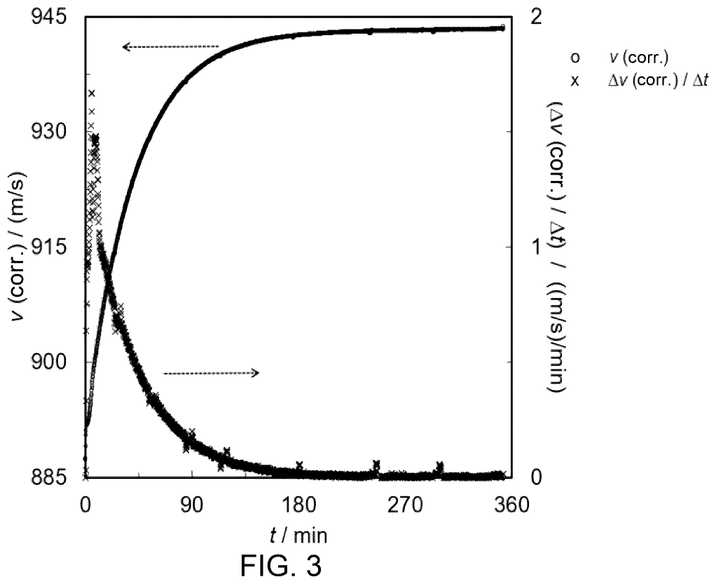

FIG. 3 shows the progression of the temperature-corrected speed of sound versus reaction time at a reaction temperature of 40° C., and the change in the temperature-corrected speed of sound per minute. The temperature-corrected speed of sound was calculated as stated further down.

The tiny variances from the ideal curve progression in the plot of this derivative of temperature-corrected speed of sound with respect to time can be explained by the sampling at the respective junctures.

The equilibration according to the invention aimed for the following average hydrosiloxane structure:

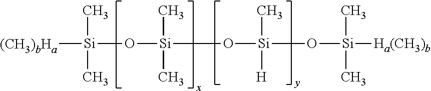

where x=36.85 and y=3.15, and a=0.92 and b=0.08.

Accompanying ²⁹Si NMR spectroscopy confirmed the obtaining of this hydrosiloxane equilibrate with such a structure.

In order not to be tied to an isothermal mode of operation, a correction function that maps the effect of temperature on the speed of sound in this hydrosiloxane equilibrate was ascertained. For this purpose, the speeds of sound were measured in the temperature range between 25° C. and 55° C., and the resultant pairs of values were correlated with one another with the aid of a calibration line. The slope of the straight line gave the change in speed of sound per degree Celsius as the derivative for the respective reference temperature T (reference).

For the above-designated hydrosiloxane equilibrate, the slope was −2.697 (m/s)/° C., and so the measured speeds of sound v (measurement) can be converted to temperature-corrected speeds of sound v (corr.):

$$v ( corr . ) = v ( measurement ) - 2.697 ( m / s ) / °C . * ( T ( reference ) - T ( measurement ) ) .$$

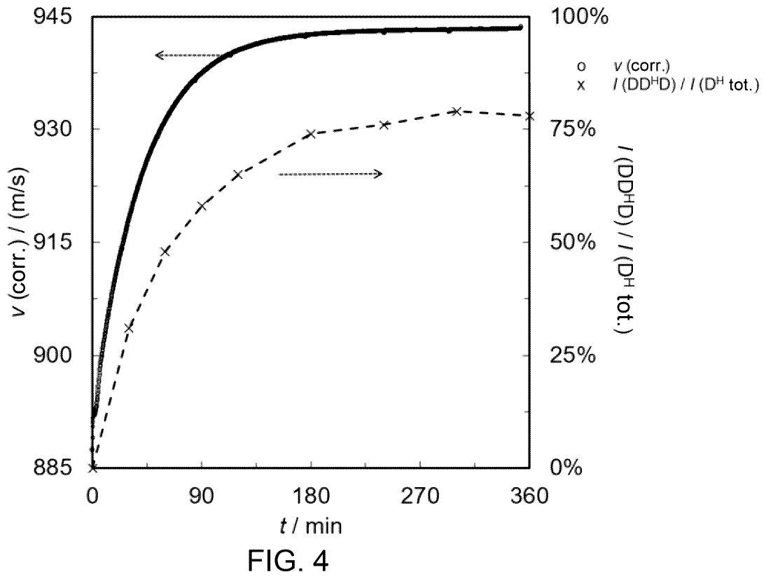

If the triad distributions ascertained beforehand in accordance with the invention by ²⁹Si NMR analysis are combined with these temperature-corrected speeds of sound determined experimentally for a dedicated hydrosiloxane, this results in the plots shown in FIG. 4.

For every juncture in the reaction, a speed of sound correlated with an individual microstructure on the way to the equilibrated hydrosiloxane. The curve (cf. FIG. 4), which describes the temperature-corrected difference in the speeds of sound, assumes an asymptotic progression.

It has been found that the particularly preferred statistical uniformity of the hydrosiloxane has already been attained when the change in speed of sound is less than 0.25% per 15 minutes, preferably less than 0.15% per 15 minutes.

TABLE 1
Evaluation of ²⁹Si NMR spectra, determination
of the proportion of DD^{H}D triads.

| Sample | t/h | I(D^{H} tot.) | I(DD^{H}D) | I(DD^{H}D)/I(D^{H} tot.) |
|---|---|---|---|---|
| Reactant mixture | 0.0 | 87.52 | 0 | 0.0 |
| Sample 1 | 0.5 | 103.77 | 32.51 | 0.31 |
| Sample 2 | 1.0 | 106.6 | 50.69 | 0.48 |
| Sample 3 | 1.5 | 107.49 | 61.81 | 0.58 |
| Sample 4 | 2.0 | 108.69 | 70.55 | 0.65 |
| Sample 5 | 3.0 | 108.31 | 79.93 | 0.74 |
| Sample 6 | 4.0 | 109.55 | 82.98 | 0.76 |
| Sample 7 | 5.0 | 106.93 | 84.71 | 0.79 |
| Sample 8 | 6.0 | 110.98 | 86.76 | 0.78 |

I(D^{H} tot.) = sum of the integrals in the shift range of −34.0 to −40.0 ppm
I(DD^{H}D) = integral from −36.8 to −38.2 ppm

1. A process for preparing unbranched hydrosiloxanes bearing dimethylhydrosiloxy groups, the process comprising:
providing a siloxane mixture comprising at least two different siloxanes and allowing said siloxane mixture to react in presence of a sulfonic acid ion exchange resin in an equilibration reaction to form a reaction mixture, where the at least two different siloxanes used collectively have dimethylhydrosiloxy groups, methylhydrosiloxy groups, and dimethylsiloxy groups, wherein
(a) the reaction mixture is monitored by ultrasound measurement in order to ascertain a suitable juncture for ending of the equilibration reaction,
(b) the equilibration reaction is ended once the suitable juncture ascertained in (a) has been reached.

2. The process according to claim 1, comprising:
detecting the speed of sound in the reaction mixture and/or the derivative of the speed of sound after the time in the reaction mixture by the ultrasound measurement.

3. The process according to claim 1, comprising:
determining the suitable juncture for ending of the equilibration reaction via a change in speed of sound in the reaction mixture.

4. The process according to claim 3, comprising:
comparing the speed of sound in the reaction mixture prior to commencement of the equilibration reaction with a progression of the speed of sound as the equilibration reaction progresses.

5. The process according to claim 1, wherein the suitable juncture for ending of the equilibration reaction has been attained when the change in speed of sound is less than 0.25% per 15 minutes.

6. The process according to claim 1, comprising:
first ascertaining the effect of a measurement temperature on the speed of sound in a respective medium in question in order to determine a correction function such that measured speeds of sound can be converted to temperature-corrected speeds of sound.

7. The process according to claim 1, comprising:
taking samples from the reaction mixture over a course of the equilibration reaction, and analysing the samples with aid of ²⁹Si NMR spectroscopy in order to detect an evolution of percentage of isolated methylhydrosiloxy groups (DD^{H}D) in the reaction mixture based on a sum total of all methylhydrosiloxy groups as a function of an equilibration time.

8. The process according to claim 1, wherein an equilibrated hydrosiloxane satisfies the following average formula: 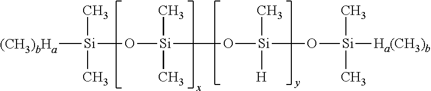
where:
$$3 \leq x \leq 1 \; 00 ,$$
$$1 \leq y \leq 30 ,$$
$$a + b = 1 ,$$
$$0.4 \leq a \leq 1. , and$$
$$0 \leq b \leq 0.6 .$$

9. The process according to claim 1, wherein the sulfonic acid ion exchange resin used is a macrocrosslinked, water-containing cation exchange resin containing sulfonic acid groups.

10. The process according to claim 1, comprising:
conducting the equilibration reaction at a temperature of 20° C. to 50° C.

11. The process according to claim 1, comprising:
accomplishing ultrasound measurement using an ultrasound measurement probe.
